(19) United States
(12) Patent Application Publication
(10) Pub. No.: US 2020/0149180 A1
(43) Pub. Date: May 14, 2020

(54) Workpiece Holding Jig and Electroplating Apparatus

(71) Applicant: C. Uyemura & Co., Ltd., Osaka-shi, Osaka (JP)

(72) Inventors: Kazuyoshi NISHIMOTO, Hirakata-shi, Osaka (JP); Shinji TACHIBANA, Hirakata-shi, Osaka (JP); Masahiro MURAKOSHI, Hirakata-shi, Osaka (JP); Tomoji OKUDA, Hirakata-shi, Osaka (JP)

(21) Appl. No.: 16/633,285

(22) PCT Filed: May 23, 2018
(86) PCT No.: PCT/JP2018/019842

§ 371 Date: Jan. 23, 2020

(30) Foreign Application Priority Data
Jul. 25, 2017 (JP) 2017-143712

(51) Int. Cl. C25D 17/08; B65G 49/04

(52) U.S. Cl. CPC C25D 17/08; B65G 49/0436

(57) ABSTRACT

A workpiece holding jig includes a back panel and a frame body, the frame body includes a main body having an annular shape, a conductive member provided all over the main body, a contact member provided along the conductive member, the contact member being electrically connected to the conductive member to come into electrical contact with a peripheral portion of the workpiece, and a seal member provided all over the main body and located on an inner side of the main body relative to the contact member, the frame body is adapted to form a sealed space that accommodates the peripheral portion of the workpiece, the conductive member, and the contact member in a state where the seal member and the contact member are in contact with the peripheral portion, and the frame body includes a liquid inlet through which a liquid is injected into the sealed space.

### TECHNICAL FIELD

The present invention relates to a workpiece holding jig for holding a rectangular plate-shaped workpiece that is an object to be electroplated, and an electroplating apparatus including the workpiece holding jig. Examples of such workpieces include a printed board, a wafer, and a semiconductor substrate (specifically, a fan-out panel level package).

### BACKGROUND ART

A workpiece holding jig for holding a rectangular plate-shaped workpiece and an electroplating apparatus including the workpiece holding jig are well known, as disclosed in Patent Documents 1 to 9.

### PRIOR ART DOCUMENTS

### Patent Documents

Patent Document 1: Japanese Patent No. 5898540

Patent Document 2: Japanese Patent Laid-open Publication No. 2016-180148

Patent Document 3: Japanese Patent Laid-open Publication No. 2016-156084

Patent Document 4: Japanese Patent Laid-open Publication No. H11-172492

Patent Document 5: Japanese Patent Laid-open Publication No. H11-140694

Patent Document 6: Japanese Patent Laid-open Publication No. H06-108285

Patent Document 7: Japanese Patent Laid-open Publication No. H05-247692

Patent Document 8: Japanese Patent Laid-open Publication No. H05-222590

Patent Document 9: Japanese Patent Laid-open Publication No. H05-218048

### SUMMARY OF THE INVENTION

### Problems to be Solved by the Invention

In such a conventional electroplating apparatus, however, a plating solution penetrates into a connection portion where the workpiece and an electrical contact terminal are connected in the workpiece holding jig, causing metal to be deposited at the connection portion and then causing the workpiece and the electrical contact terminal to adhere to each other, which makes it difficult to remove the workpiece from the workpiece holding jig.

Further, in order to evenly plate an entire surface of the workpiece, the conventional electroplating apparatus has a structure where, for example, all wires extending to the electrical contact terminals are made equal in length to each other, which makes the apparatus structure complicated.

It is therefore an object of the present invention to provide a workpiece holding jig and an electroplating apparatus that can eliminate at least one of the above-described problems.

### Solutions to the Problems

According to a first aspect of the present invention, provided is a workpiece holding jig for holding a workpiece having a plate shape, the workpiece being an object to be electroplated. The workpiece holding jig includes a back panel, and a frame body, the workpiece is held between the back panel and the frame body, the frame body is configured to be attached to the back panel to hold a peripheral portion of the workpiece between the frame body and the back panel, the frame body includes a main body having an annular shape, a conductive member provided all over the main body, a contact member provided along the conductive member, the contact member being electrically connected to the conductive member to come into electrical contact with the peripheral portion of the workpiece, and a seal member provided all over the main body, the seal member being located on an inner side of the main body relative to the contact member, the frame body is adapted to form a sealed space that accommodates the peripheral portion of the workpiece, the conductive member, and the contact member in a state where the seal member and the contact member are in contact with the peripheral portion of the workpiece, and the conductive member has a wide and thick form to exhibit an approximately uniform resistance value at any point all over the conductive member.

According to a second aspect of the present invention, provided is a workpiece holding jig for holding a workpiece having a plate shape, the workpiece being an object to be electroplated. The workpiece holding jig includes a back panel, and a frame body, the workpiece is held between the back panel and the frame body, the frame body is configured to be attached to the back panel to hold a peripheral portion of the workpiece between the frame body and the back panel, the frame body includes a main body having an annular shape, a wire provided all over the main body, a contact member provided along the wire, the contact member being electrically connected to the wire to come into electrical contact with the peripheral portion of the workpiece, and a seal member provided all over the main body, the seal member being located on an inner side of the main body relative to the contact member, the frame body is adapted to form a sealed space that accommodates the peripheral portion of the workpiece, the wire, and the contact member in a state where the seal member and the contact member are in contact with the peripheral portion of the workpiece, and the frame body or the back panel includes a liquid inlet through which a liquid is injected into the sealed space.

According to a third aspect of the present invention, provided is an electroplating apparatus including the workpiece holding jig according to the first or second aspect, the electroplating apparatus being configured to hold the workpiece with the workpiece holding jig and electroplate the workpiece thus held. The electroplating apparatus includes a plating bath configured to hold a plating solution and electroplate the workpiece, and a transfer mechanism configured to load and unload the workpiece holding jig holding the workpiece into and from the plating bath, and the sealed space in the workpiece holding jig is filled with a liquid that contains no metal salt.

### Effects of the Invention

According to the first and third aspects of the present invention, it is possible to evenly distribute a current all over the workpiece having a plate shape and is thus possible to evenly plate an entire surface to be processed of the workpiece.

According to the second and third aspects of the present invention, when the workpiece is plated, it is possible to prevent the plating solution from entering the sealed space and is thus possible to prevent metal generating from the plating solution from being deposited on the peripheral portion of the workpiece or the contact member. Accordingly, when the workpiece that has been plated is removed from the workpiece holding jig, it is possible to prevent the workpiece or the contact member from being damaged.

### BRIEF DESCRIPTION OF THE DRAWINGS

FIG. 1 is a plan view of an electroplating apparatus according to a first embodiment of the present invention.

FIG. 2 is a schematic cross-sectional view taken along a line II-II in FIG. 1.

FIG. 3 is an exploded perspective view of a workpiece holding jig according to the first embodiment.

FIG. 4 shows a frame body as viewed from an arrow IV in FIG. 3.

FIG. 5 shows a portion corresponding to a V-V cross section in FIG. 3, showing a state where the frame body is not attached to a back panel.

FIG. 6 shows the portion corresponding to the V-V cross section in FIG. 3, showing a state where the frame body is attached to the back panel.

FIG. 7 is a schematic cross-sectional view taken along a line VII-VII in FIG. 2.

FIG. 8 is a plan view of an electroplating apparatus according to a second embodiment of the present invention.

FIG. 9 is a schematic cross-sectional view taken along a line IX-IX in FIG. 8.

FIG. 10 is an exploded perspective view of a workpiece holding jig according to the second embodiment.

FIG. 11 is a schematic cross-sectional view taken along a line XI-XI in FIG. 9.

FIG. 12 is a diagram corresponding to FIG. 5, showing a different embodiment of the present invention.

FIG. 13 is a diagram corresponding to FIG. 6, showing the different embodiment of the present invention.

FIG. 14 is a diagram corresponding to FIG. 4, showing another example of a comb-shaped contact member.

### EMBODIMENTS OF THE INVENTION

### First Embodiment

### (Overall Structure)

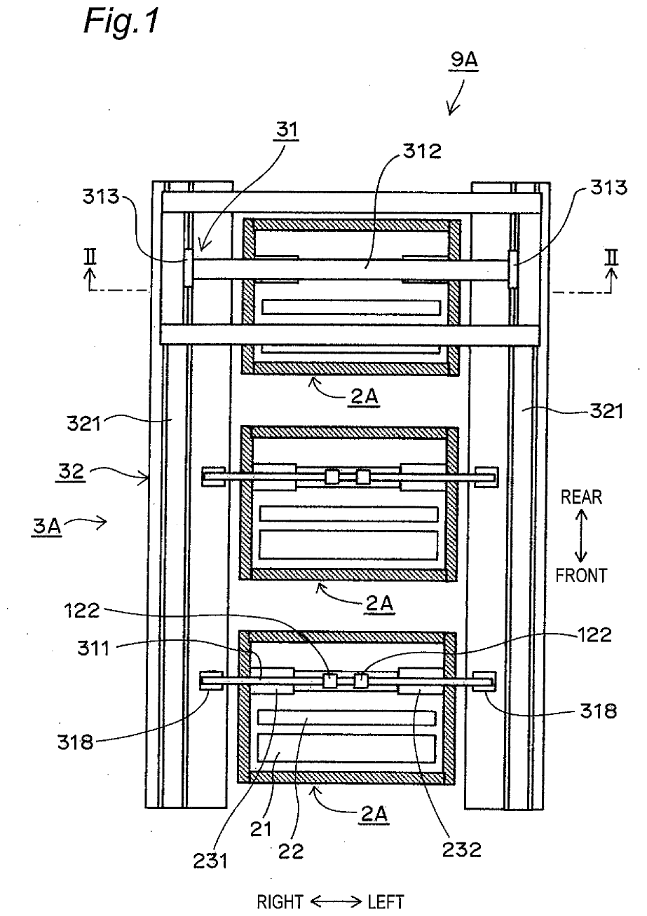

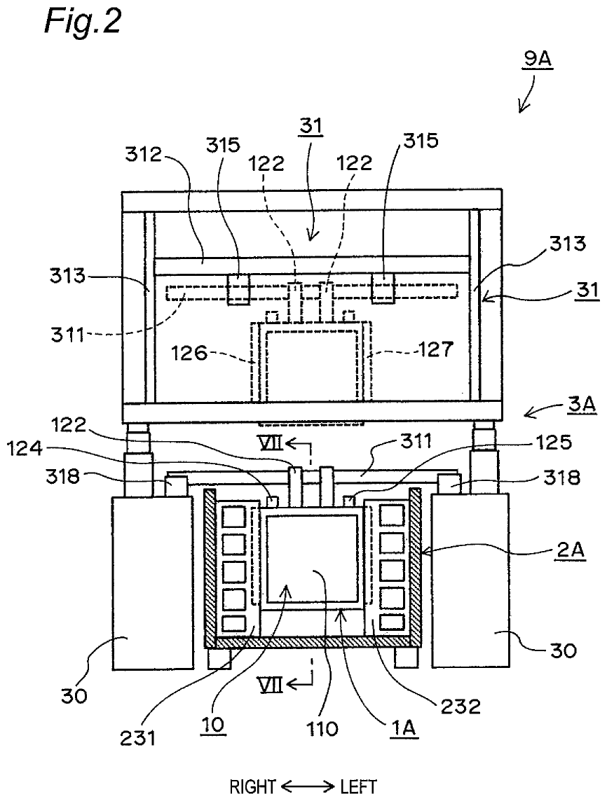

FIG. 1 is a plan view of an electroplating apparatus according to a first embodiment of the present invention. FIG. 2 is a schematic cross-sectional view taken along a line II-II in FIG. 1. This electroplating apparatus 9A includes a workpiece holding jig 1A, a plating bath 2A, and a transfer mechanism 3A. The workpiece holding jig 1A is configured to hold a workpiece 10 having a rectangular plate shape. The plating bath 2A is configured to plate the workpiece 10 held by the workpiece holding jig 1A. According to the present embodiment, three plating baths 2A are arranged in a row. The transfer mechanism 3A is configured to load and unload the workpiece holding jig 1A holding the workpiece 10 into and from each of the plating baths 2A in a vertical direction.

(Workpiece Holding Jig)

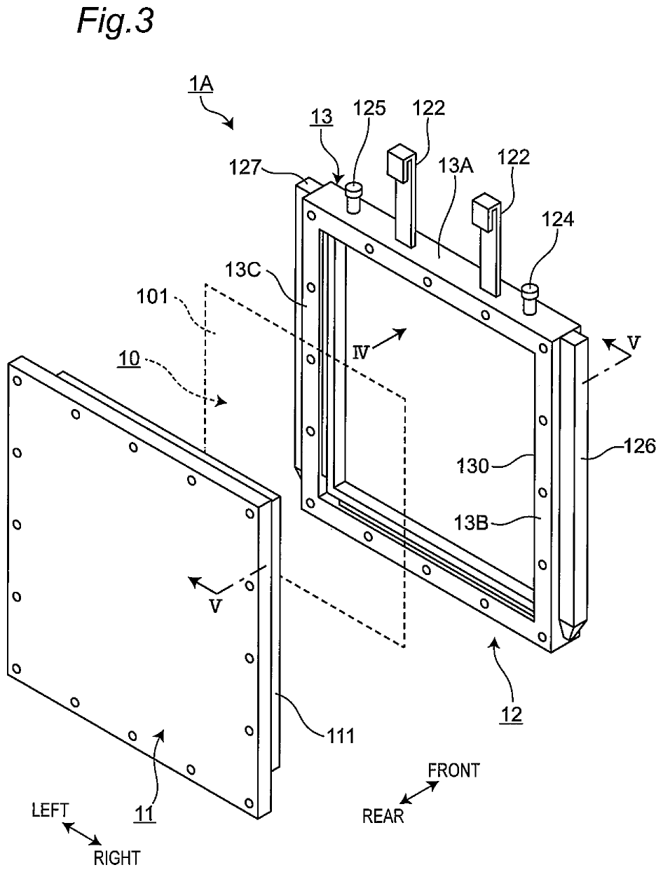

FIG. 3 is an exploded perspective view of the workpiece holding jig 1A. The workpiece holding jig 1A includes a back panel 11 having a rectangular shape and a frame body 12 having a rectangular shape and is configured to hold the workpiece 10 having a plate shape between the back panel 11 and the frame body 12. The back panel 11 is adapted to allow the workpiece 10 to be placed on the back panel 11. The frame body 12 is adapted to be attached to the back panel 11 to hold a peripheral portion 101 of the workpiece 10 between the frame body 12 and the back panel 11. The back panel 11 and the frame body 12 are made of, for example, a vinyl chloride resin.

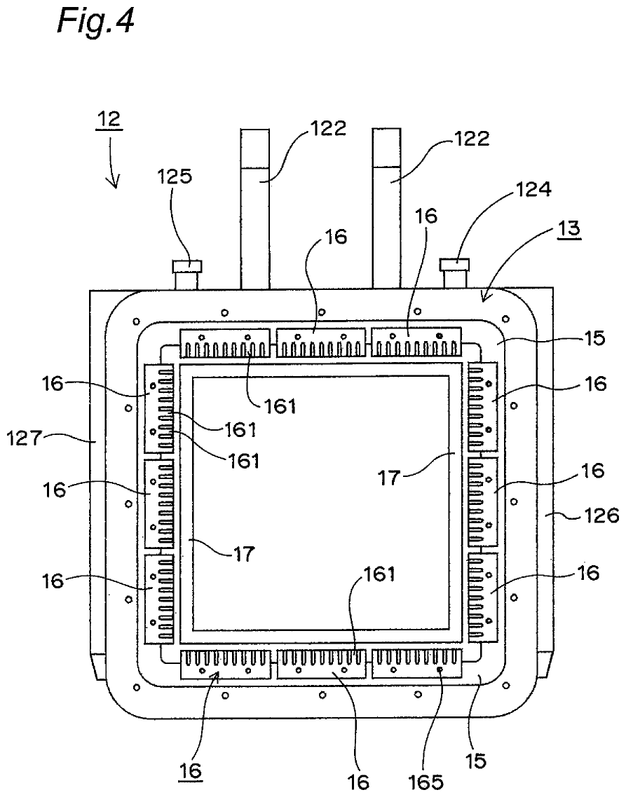

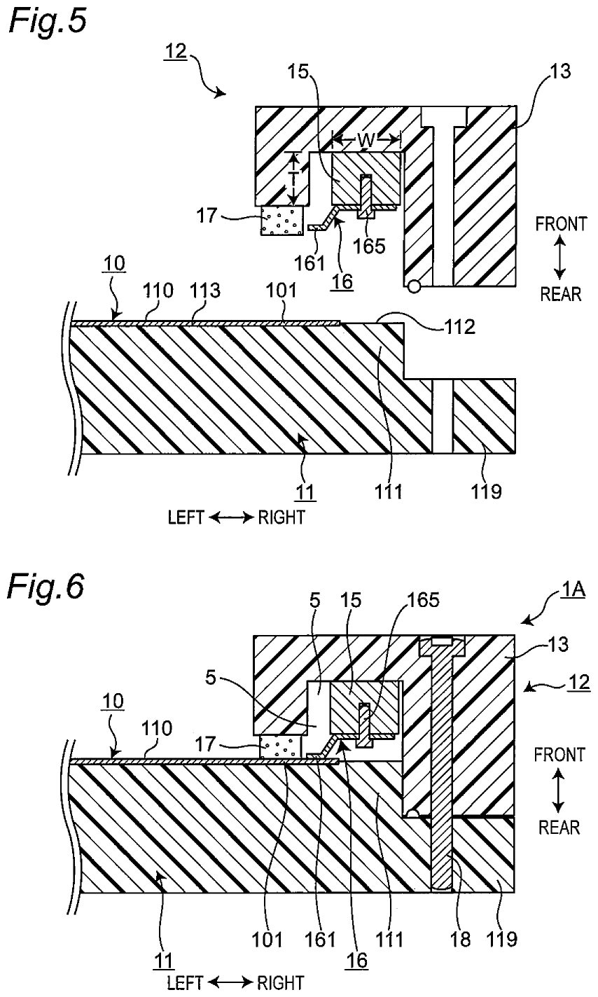

FIG. 4 shows the frame body 12 as viewed from an IV arrow in FIG. 3. FIG. 5 and FIG. 6 are diagrams each corresponding to a V-V cross section in FIG. 3, FIG. 5 shows a state where the frame body 12 is not attached to the back panel 11, and FIG. 6 shows a state where the frame body 12 is attached to the back panel 11. That is, FIG. 6 shows a state where the workpiece holding jig 1A holds the workpiece 10.

The frame body 12 includes a main body 13 having a rectangular annular shape, a conductive member 15 provided all over the main body 13, a contact member 16 provided along the conductive member 15, the contact member 16 being electrically connected to the conductive member 15 to come into electrical contact with the peripheral portion 101 of the workpiece 10, and a seal member 17 provided all over the main body 13 and located on an inner side of the main body 13 relative to the contact member 16. The contact member 16 is provided on each side of the main body 13.

The back panel 11 includes a raised portion 111 that fits into a rear opening 130 of the main body 13, and the workpiece 10 is adapted to be fitted into a shallow recessed portion 113 formed on an end surface 112 of the raised portion 111.

As shown in FIG. 5 and FIG. 6, the conductive member 15 has a width W and a thickness T and is wider and thicker than the conventional conductive members. This allows the conductive member 15 to have a characteristic of exhibiting an approximately uniform resistance value at any point all over the conductive member 15. Specifically, the conductive member 15 has a cross-sectional area (W×T) of 50 to 900 mm². A cross-sectional area less than 50 mm² causes the conductive member 15 to hardly exhibit the above-described characteristic, and a cross-sectional area greater than 900 mm² makes the conductive member 15 too heavy and thus makes it difficult to handle the conductive member 15. The conductive member 15 is made of, for example, copper or titanium coated with a vinyl chloride resin. The conductive member 15 is also referred to as a “bus bar”.

The contact member 16 is a comb-shaped contact member including a large number of contact terminals 161 that have a leaf spring shape and are arranged side by side to come into electrical contact with the peripheral portion 101 of the workpiece 10. According to the present embodiment, the comb-shaped contact member 16 is divided into three pieces on each side of the main body 13. The contact member 16 is fixed to the conductive member 15 with bolts 165. The bolts 165 appear on a rear surface side of the frame body 12, which makes the replacement work of the contact member 16 easy. Note that the contact member 16 is replaced when restoring force of the contact terminals 161 becomes weak. The contact terminals 161 are made of, for example, copper coated with gold.

Further, the frame body 12 forms a sealed space 5 that accommodates the peripheral portion 101 of the workpiece 10, the conductive member 15, and the contact member 16 in the state shown in FIG. 6, that is, with the seal member 17 and the contact terminals 161 of the contact member 16 in contact with the peripheral portion 101. The seal member 17 is made of, for example, a sponge rubber. The seal member 17 is compressed and brought into close contact with the peripheral portion 101 of the workpiece 10. Note that the frame body 12 is attached to the back panel 11 by being fixed to a peripheral portion 119 of the back panel 11 with bolts 18.

On an upper surface of an upper side 13A of the main body 13, provided are two handles 122 extending upward, and a liquid inlet 124 and an air vent 125 used for injecting a liquid into the sealed space 5. The handles 122 are electrically connected to the conductive member 15. Further, on a side surface of a right side 13B of the main body 13, provided is a right guide bar 126 protruding in a lateral direction and extending along the right side 13B, and, on a side surface of a left side 13C, provided is a left guide bar 127 protruding in the lateral direction and extending along the left side 13C.

(Plating Bath)

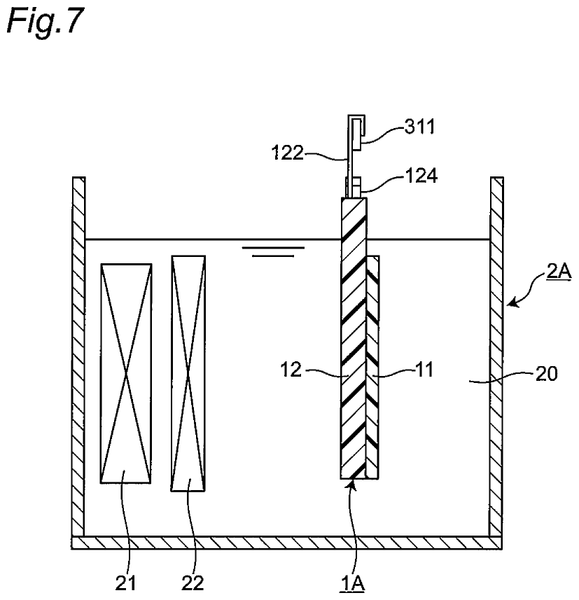

FIG. 7 is a schematic cross-sectional view taken along a line VII-VII in FIG. 2. The plating baths 2A are each filled with a plating solution 20 and include an anode 21 and a jet mechanism 22. The plating baths 2A are each adapted to cause electricity to flow between the anode 21 and the workpiece 10 held by the workpiece holding jig 1A to plate a surface to be processed 110 of the workpiece 10. In each of the plating baths 2A, the plating solution 20 is sprayed onto the surface 110 to be processed of the workpiece 10 by the jet mechanism 22 during the plating, so that the fresh plating solution 20 always comes into contact with the surface 110 to be processed, which allows the plating to be made effectively.

As shown in FIG. 2, the plating baths 2A further include a guide member that guides the workpiece holding jig 1A when the workpiece holding jig 1A is loaded into each of the plating baths 2A. Specifically, the guide member includes a right guide rail 231 that guides the right guide bar 126 of the workpiece holding jig 1A, and a left guide rail 232 that guides the left guide bar 127 of the workpiece holding jig 1A. The guide rails are vertical grooves through which the guide bars slide in the vertical direction. Note that the guide member also serves as a support member that supports the workpiece holding jig 1A in an upright position.

(Transfer Mechanism)

The transfer mechanism 3A includes a vertical transfer mechanism 31 configured to load and unload the workpiece holding jig 1A into and from each of the plating baths 2A in the vertical direction and a first conveying mechanism 32 configured to convey the workpiece holding jig 1A to a loading and unloading position with respect to each of the plating baths 2A.

The vertical transfer mechanism 31 includes a carrier bar 311, a hoisting bar 312, and a pair of left and right hoisting rails 313. The carrier bar 311 is held by the hoisting bar 312 via two holding portions 315. To a center of the carrier bar 311, the workpiece holding jig 1A is hooked via the two handles 122. The vertical transfer mechanism 31 is adapted to move the hoisting bar 312 that holds the carrier bar 311 to which the workpiece holding jig 1A is hooked up and down along the hoisting rail 313 to load and unload the workpiece holding jig 1A into and from each of the plating baths 2A. Note that the workpiece holding jig 1A holding the workpiece 10 is hooked to the carrier bar 311 such that the surface 110 to be processed of the workpiece 10 faces the jet mechanism 22.

The first conveying mechanism 32 includes a pair of left and right horizontal rails 321 and is adapted to move, above the three plating baths 2A arranged in a row, the hoisting rail 313 supporting the hoisting bar 312 along the horizontal rails 321 in a horizontal direction to the loading and unloading position with respect to each of the plating baths 2A. As described above, the first conveying mechanism 32 can convey the workpiece holding jig 1A hooked to the carrier bar 311 held by the hoisting bar 312 to the loading and unloading position with respect to a desired one of the plating baths 2A.

(Operation)

The electroplating apparatus 9A configured as described above operates as follows.

### (1) Workpiece Holding

First, the back panel 11 is laid on a floor. Next, the workpiece 10 is fitted into the recessed portion 113 of the raised portion 111 of the back panel 11. Next, the frame body 12 is placed on the back panel 11 from above and is fixed to the peripheral portion 119 with the bolts 18. This causes the workpiece 10 to be held by the workpiece holding jig 1A and forms the sealed space 5 as shown in FIG. 6 on the peripheral portion 101 of the workpiece 10.

(2) Liquid Injection

The workpiece holding jig 1A holding the workpiece 10 is raised in an upright position and is hooked to the center of the carrier bar 311 via the handles 122. Then, a liquid is injected into the sealed space 5 from the liquid inlet 124. At this time, air in the sealed space 5 is surely purged through the air vent 125, so that the liquid is smoothly injected. Note that, as the liquid to be injected into the sealed space 5, a liquid that contains no metal salt is used. “Contains no metal salt” means “concentration of all metal salts contained is equal to or less than 5 g/L”. Specifically, tap water, natural water, or pure water is used as such a liquid. As pure water, deionized water, distilled water, purified water, or RO water is used.

(3) Conveyance

The first conveying mechanism 32 is put into operation to convey the workpiece holding jig 1A to the loading and unloading position with respect to each of the plating baths 2A. FIG. 1 shows a state where the first conveying mechanism 32 conveys the workpiece holding jig 1A to a plating bath 2A located on an innermost side.

(4) Loading

The vertical transfer mechanism 31 is put into operation to load the workpiece holding jig 1A into each of the plating baths 2A. A support base 30 of the transfer mechanism 3A is disposed adjacent to both sides of the plating baths 2A, and a bar placing base 318 is provided on the support base 30. The vertical transfer mechanism 31 lowers the hoisting bar 312 to a position where the carrier bar 311 is allowed to be placed on the bar placing base 318, and when the carrier bar 311 is placed on the bar placing base 318, the vertical transfer mechanism 31 disengages the holding portion 315 from the carrier bar 311 and raises the hoisting bar 312. This causes the workpiece holding jig 1A to be loaded into each of the plating baths 2A with the workpiece holding jig 1A hooked to the carrier bar 311. At this time, since the left and right guide bars 126, 127 are guided by the left and right guide rails 231, 232, the workpiece holding jig 1A is smoothly loaded with the upright position maintained.

(5) Plating

A power switch (not shown) is set to an on position to supply a current to the workpiece 10 and the anode 21. This forms an electric field between the workpiece 10 and the anode 21 to plate the workpiece 10. A current is supplied to the workpiece 10 from a power source (not shown) through a current-carrying path (not shown), the bar placing base 318, the carrier bar 311, the handles 122, the conductive member 15, and the contact member 16. At this time, since the sealed space 5 is filled with a liquid, it is possible to prevent the plating solution 20 from entering the sealed space 5. When the sealed space 5 is not filled with a liquid, the plating solution 20 enters the sealed space 5 due to a pressure difference between the inside and outside of the sealed space 5.

(6) Unloading

The vertical transfer mechanism 31 is put into operation to lower the hoisting bar 312, put the holding portion 315 into operation to hold the carrier bar 311 and raise the hoisting bar 312. This causes the workpiece holding jig 1A to be raised together with the carrier bar 311 and unloaded upward from the plating bath 2A.

(Effect)

(a) With the workpiece holding jig 1A configured as described above, the sealed space 5 that accommodates the peripheral portion 101 of the workpiece 10, the conductive member 15, and the contact member 16 can be formed, and a liquid can be injected into the sealed space 5 from the liquid inlet 124. Therefore, the following effects can be exhibited by injecting a liquid into the sealed space 5.

(a1) When the workpiece 10 is plated, it is possible to prevent the plating solution 20 from entering the sealed space 5 and it is thus possible to prevent metal generating from the plating solution 20 from being deposited on the peripheral portion 101 of the workpiece 10 or the contact member 16. Accordingly, when the workpiece 10 that has been plated is removed from the workpiece holding jig 1A, it is possible to prevent the workpiece 10 or the contact member 16 from being damaged.

(a2) Heat generated by a current flowing between the peripheral portion 101 of the workpiece 10 and the contact member 16 can be reduced by the liquid in the sealed space 5, thereby preventing the peripheral portion 101 of the workpiece 10 and the contact member 16 from being damaged and adhering to each other.

(b) With the workpiece holding jig 1A configured as described above, since the conductive member 15 is wider and thicker than the conventional conductive members, the conductive member 15 can have an approximately uniform resistance value at any point all over the conductive member 15, thereby allowing a current to be evenly distributed all over the workpiece 10 and thus allowing the entire surface 110 to be processed of the workpiece 10 to be evenly plated.

(c) With the workpiece holding jig 1A configured as described above, since the contact member 16 is a comb-shaped contact member, even when the conductive member 15 has a wide and thick form, it is possible to satisfactorily supply a current to the workpiece 10.

(d) With the workpiece holding jig 1A configured as described above, since the comb-shaped contact member 16 is divided into three pieces on each side of the main body 13, only a broken member 16 can be easily replaced.

(e) With the electroplating apparatus 9A configured as described above, since the sealed space 5 in the workpiece holding jig 1A is filled with a liquid, the following effects can be exhibited.

(e1) When the workpiece 10 is plated, it is possible to prevent the plating solution 20 from entering the sealed space 5 and it is thus possible to prevent metal generating from the plating solution 20 from being deposited on the peripheral portion 101 of the workpiece 10 or the contact member 16. Accordingly, when the workpiece 10 that has been plated is removed from the workpiece holding jig 1A, it is possible to prevent the workpiece 10 or the contact member 16 from being damaged.

(e2) Heat generated by a current flowing between the peripheral portion 101 of the workpiece 10 and the contact member 16 can be reduced by the liquid in the sealed space 5, thereby preventing the peripheral portion 101 of the workpiece 10 and the contact member 16 from being damaged and adhering to each other.

(f) With the electroplating apparatus 9A configured as described above, since the workpiece holding jig 1A is loaded and unloaded into and from each of the plating baths 2A in the vertical direction, an area where the apparatus is installed can be reduced.

(g) With the electroplating apparatus 9A configured as described above, since the left and right guide bars 126, 127 are guided by the left and right guide rails 231, 232 when the workpiece holding jig 1A is loaded into each of the plating baths 2A, the workpiece holding jig 1A can be smoothly loaded with the upright position maintained.

### Second Embodiment

(Overall Structure)

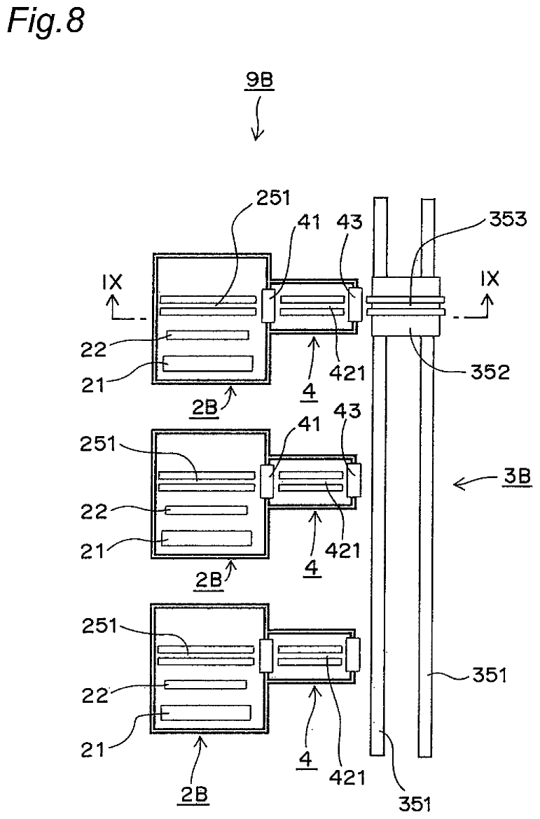

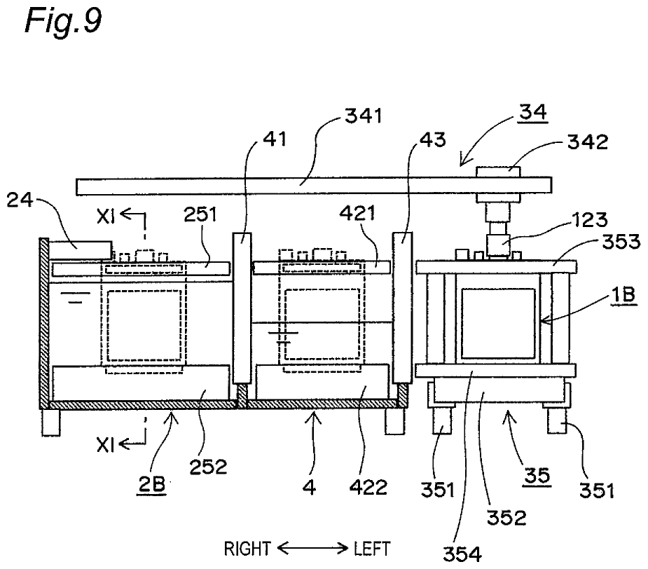

FIG. 8 is a plan view of an electroplating apparatus 9B according to a second embodiment of the present invention. FIG. 9 is a schematic cross-sectional view taken along a line IX-IX in FIG. 8. The electroplating apparatus 9B includes a workpiece holding jig 1B, a plating bath 2B and a flux-reflux bath 4, and a transfer mechanism 3B. The workpiece holding jig 1B is configured to hold a workpiece having a rectangular plate shape. The plating bath 2B is configured to plate the workpiece held by the workpiece holding jig 1B. According to the present embodiment, three plating baths 2B are arranged in a row, and the flux-reflux bath 4 is disposed in front of each of the plating baths 2B. The transfer mechanism 3B is configured to load and unload the workpiece holding jig 1B holding the workpiece into and from each of the plating baths 2B in the horizontal direction.

(Workpiece Holding Jig)

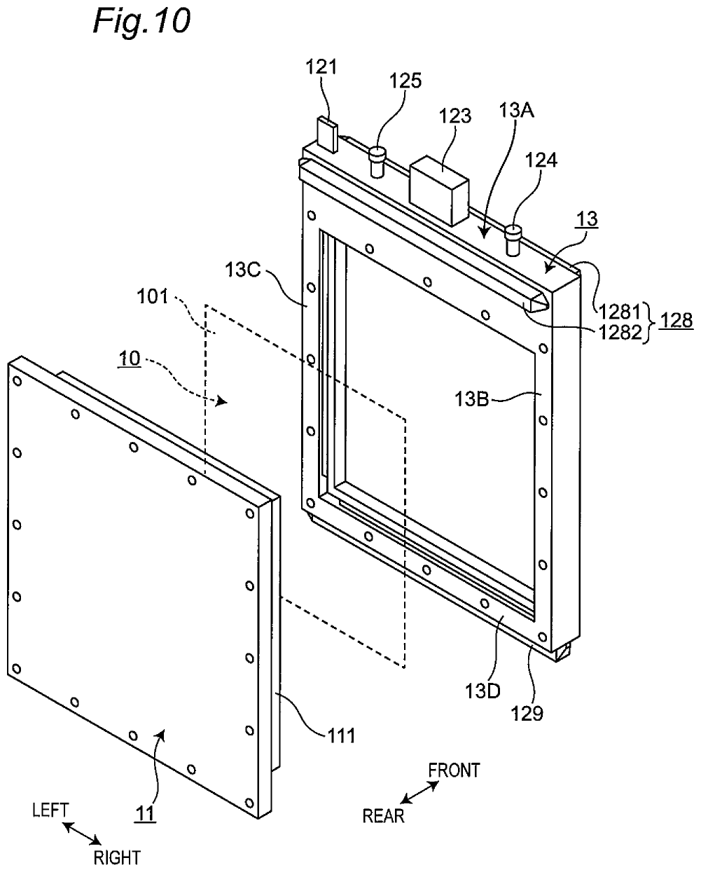

FIG. 10 is an exploded perspective view of the workpiece holding jig 1B. The workpiece holding jig 1B is different from the workpiece holding jig 1A according to the first embodiment only in the following points and is identical to the workpiece holding jig 1A in other structures, that is, the liquid inlet 124, the air vent 125, the main body 13, the conductive member 15, the contact member 16, and the like.

(i) Rather than the handles 122, a holding portion 123 is provided on the upper side 13A of the main body 13. Note that the holding portion 123 is not electrically connected to the conductive member 15.

(ii) A current-carrying terminal 121 is provided at an end of the upper side 13A of the main body 13. Note that the current-carrying terminal 121 is electrically connected to the conductive member 15.

(iii) Rather than the left and right guide bars 126, 127, upper and lower guide bars 128, 129 are provided. The upper guide bar 128 is provided along the upper side 13A of the main body 13 and includes an upper front guide bar 1281 protruding forward from a front surface of the upper side 13A and an upper rear guide bar 1282 protruding rearward from a rear surface of the upper side 13A. The lower guide bar 129 is provided along the lower side 13D of the main body 13 and protrudes downward from a lower surface of the lower side 13D.

(Plating Bath)

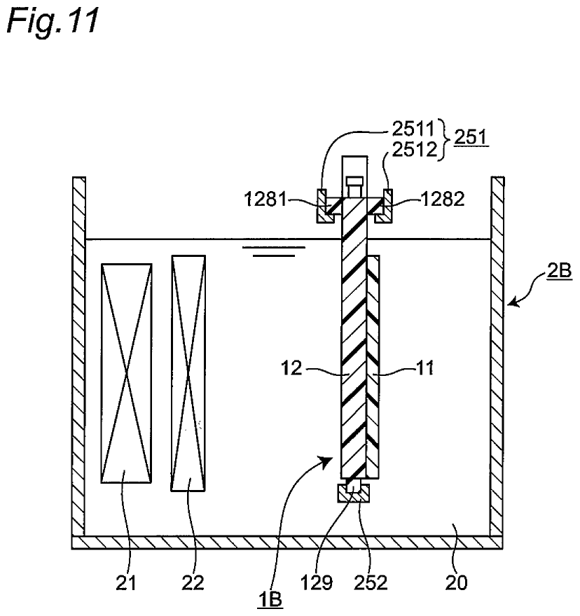

FIG. 11 is a schematic cross-sectional view taken along a line XI-XI in FIG. 9. The plating baths 2B are different from the plating baths 2A according to the first embodiment only in the following points and are identical to the plating baths 2A in other structures, that is, the plating solution 20, the anode 21, the jet mechanism 22, and the like.

(i) A current-carrying portion 24 is provided. The current-carrying portion 24 is provided to come into contact with the current-carrying terminal 121 when the workpiece holding jig 1B is loaded into each of the plating baths 2B.

(ii) Rather than the left and right guide rails 231, 232, upper and lower guide rails 251, 252 that guide the upper and lower guide bars 128, 129 when the workpiece holding jig 1B is loaded and unloaded into and from each of the plating baths 2B in the horizontal direction are provided. The upper guide rail 251 includes an upper front guide rail 2511 that guides the upper front guide bar 1281 and an upper rear guide rail 2512 that guides the upper rear guide bar 1282. Note that the guide rails have lateral grooves that allow the guide bars to slide in the horizontal direction.

(iii) The flux-reflux bath 4 is provided in a fore stage. That is, the flux-reflux bath 4 is disposed in front of a corresponding one of the plating baths 2B, and a first opening and closing gate 41 serves as a partition between the plating bath 2B and the flux-reflux bath 4. The flux-reflux bath 4 includes upper and lower guide rails 421, 422 that guide the upper and lower guide bars 128, 129 when the workpiece holding jig 1B is loaded and unloaded into and from the flux-reflux bath 4 in the horizontal direction. The upper and lower guide rails 421, 422 are identical in structure to the upper and lower guide rails 251, 252 of the plating baths 2B. Further, the flux-reflux bath 4 includes a second opening and closing gate 43 on a side opposite from the first opening and closing gate 41. Both the opening and closing gates 41, 43 are adapted to open and close in a left-right direction.

(Transfer Mechanism)

The transfer mechanism 3B includes a horizontal transfer mechanism 34 configured to load and unload the workpiece holding jig 1B into and from each of the plating baths 2B in the horizontal direction and a second conveying mechanism 35 configured to convey the workpiece holding jig 1B to a loading and unloading position with respect to each of the plating baths 2B.

The horizontal transfer mechanism 34 includes a transfer rail 341 and a transfer unit 342. The transfer rail 341 is provided extending above and across both the flux-reflux bath 4 and the plating bath 2B. The transfer unit 342 is provided to hold the workpiece holding jig 1B in an upright position with the holding portion 123 and move along the transfer rail 341 together with the workpiece holding jig 1B.

The second conveying mechanism 35 includes a pair of left and right horizontal rails 351 and a conveying base 352. The horizontal rails 351 extend along three flux-reflux baths 4 arranged in a row. On the conveying base 352, an upper guide rail 353 and a lower guide rail 354 are provided, the upper guide rail 353 being identical to the upper guide rails 251 of the plating baths 2B and the upper guide rails 421 of the flux-reflux baths 4, the lower guide rail 354 being identical to the lower guide rails 252 of the plating baths 2B and the lower guide rails 422 of the flux-reflux baths 4. The conveying base 352 is adapted to convey the workpiece holding jig 1B held by the transfer unit 342 and supported by the upper guide rail 353 and the lower guide rail 354 along the horizontal rails 351 together with the transfer rail 341. As described above, the second conveying mechanism 35 can convey the workpiece holding jig 1B held by the transfer unit 342 to the loading and unloading position with respect to a desired one of the plating baths 2B.

(Operation)

The electroplating apparatus 9B configured as described above operates as follows.

(1) Workpiece Holding

In the same manner as in the first embodiment, the workpiece 10 is held by the workpiece holding jig 1B. This forms the sealed space 5 as shown in FIG. 6 on the peripheral portion 101 of the workpiece 10.

(2) Liquid Injection

The workpiece holding jig 1B holding the workpiece 10 is raised in an upright position, the lower guide bar 129 is fitted into the lower guide rail 354 of the conveying base 352, and the holding portion 123 is held by the transfer unit 342. Then, a liquid is injected into the sealed space 5 from the liquid inlet 124. At this time, air in the sealed space 5 is surely purged through the air vent 125, so that the liquid is smoothly injected.

(3) Conveyance

The second conveying mechanism 35 is put into operation to convey the workpiece holding jig 1B to the loading and unloading position with respect to each of the plating baths 2B. FIG. 8 shows a state where the second conveying mechanism 35 conveys the workpiece holding jig 1B to a plating bath 2B located on an innermost side.

(4) Loading

First, the second opening and closing gate 43 is opened. At this time, the first opening and closing gate 41 is closed, and the plating bath 2B is filled with the plating solution 20. Next, the horizontal transfer mechanism 34 is put into operation to move the transfer unit 342 along the transfer rail 341 together with the workpiece holding jig 1B to load the workpiece holding jig 1B into a corresponding one of the flux-reflux baths 4. Next, the second opening and closing gate 43 is closed. Next, the plating solution 20 is injected into the flux-reflux bath 4 to fill the flux-reflux bath 4 with the plating solution 20. Next, the first opening and closing gate 41 is opened. Next, the horizontal transfer mechanism 34 is put into operation to move the transfer unit 342 along the transfer rail 341 together with the workpiece holding jig 1B to unload the workpiece holding jig 1B from the flux-reflux bath 4 and load the workpiece holding jig 1B into the plating bath 2B. Next, the first opening and closing gate 41 is closed. This causes the workpiece holding jig 1B to be loaded into the plating bath 2B. Note that, at this time, since the lower guide bar 129 is guided by the lower guide rail 354 of the conveying base 352, the lower guide rail 422 of the flux-reflux bath 4, and the lower guide rail 252 of the plating bath 2B, and the upper guide bar 128 is guided by the upper guide rail 421 of the flux-reflux bath 4 and the upper guide rail 251 of the plating bath 2B, the workpiece holding jig 1B is smoothly loaded into the flux-reflux bath 4 and the plating bath 2B with the upright position maintained.

(5) Plating

A power switch (not shown) is set to an on position to supply a current to the workpiece 10 and the anode 21. This forms an electric field between the workpiece 10 and the anode 21 to plate the workpiece 10. A current is supplied to the workpiece 10 from a power source (not shown) through a current-carrying path (not shown), the current-carrying portion 24, the current-carrying terminal 121, the conductive member 15, and the contact member 16. At this time, since the sealed space 5 is filled with a liquid, it is possible to prevent the plating solution 20 from entering the sealed space 5. Accordingly, it is possible to prevent metal generating from the plating solution 20 from being deposited on the peripheral portion 101 of the workpiece 10 or the contact member 16. When the sealed space 5 is not filled with a liquid, the plating solution 20 enters the sealed space 5 due to a pressure difference between the inside and outside of the sealed space 5.

(6) Unloading

First, the first opening and closing gate 41 is opened. Next, the horizontal transfer mechanism 34 is put into operation to move the transfer unit 342 along the transfer rail 341 together with the workpiece holding jig 1B to unload the workpiece holding jig 1B from the plating bath 2B and then load the workpiece holding jig 1B into the flux-reflux bath 4. Next, the first opening and closing gate 41 is closed. Next, the plating solution 20 is discharged from the flux-reflux bath 4. Next, the second opening and closing gate 43 is opened. Next, the horizontal transfer mechanism 34 is put into operation to move the transfer unit 342 along the transfer rail 341 together with the workpiece holding jig 1B to unload the workpiece holding jig 1B from the flux-reflux bath 4.

(Effect)

With the workpiece holding jig 1B and the electroplating apparatus 9B configured as described above, effects the same as the effects (a) to (e) according to the first embodiment can be exhibited. Furthermore, the following effects can be exhibited.

(f) With the electroplating apparatus 9B configured as described above, since the workpiece holding jig 1B is loaded and unloaded into and from each of the plating baths 2B in the horizontal direction, a space area where the apparatus is installed can be lowered.

(g) With the electroplating apparatus 9B configured as described above, since the upper and lower guide bars 128, 129 are guided by the upper and lower guide rails 251, 252; 421, 422 when the workpiece holding jig 1B is loaded into each of the plating baths 2B, the workpiece holding jig 1B can be smoothly loaded with the upright position maintained.

### Other Embodiments

The present invention may employ other structures as described below.

(1) In the workpiece holding jigs 1A, 1B according to the above-described embodiments, neither the liquid inlet 124 nor the air vent 125 is provided. Therefore, in an electroplating apparatus including such a workpiece holding jig, the sealed space 5 is not filled with a liquid. This structure can also exhibit effects other than (a) and (e) according to the above-described embodiments.

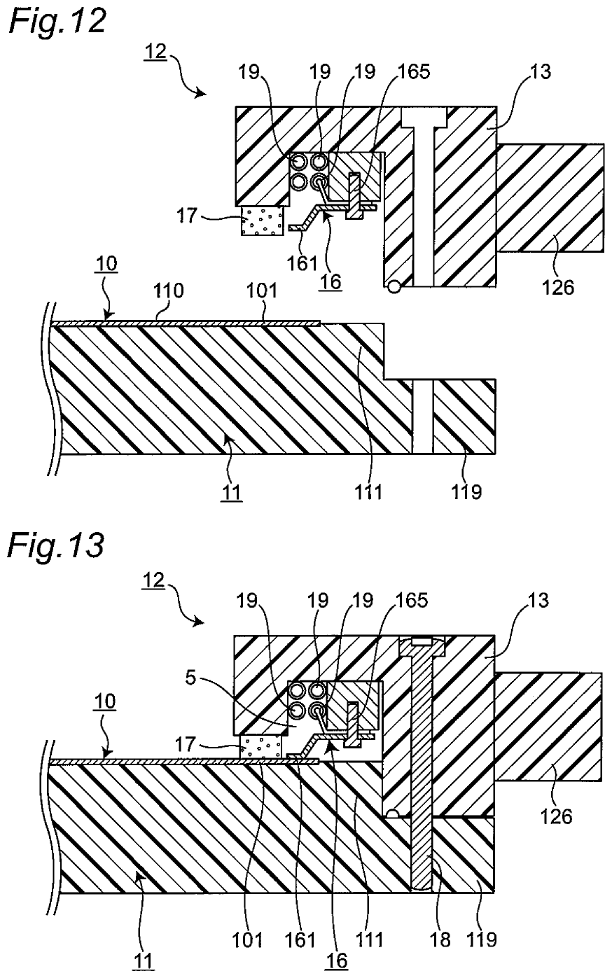

(2) In the workpiece holding jigs 1A, 1B according to the above-described embodiments, as shown in FIG. 12 and FIG. 13, the contact member 16 is electrically connected to a wire 19 rather than the conductive member 15. Note that FIG. 12 corresponds to FIG. 5, and FIG. 13 corresponds to FIG. 6. A plurality of the wires 19 are provided, and each of the contact members 16 is connected with a corresponding one of wires 19 that is identical in length to the contact member 16. In an electroplating apparatus including such a workpiece holding jig, the sealed space 5 is filled with a liquid. This structure can also exhibit the same effects as the effects according to the above-described embodiments.

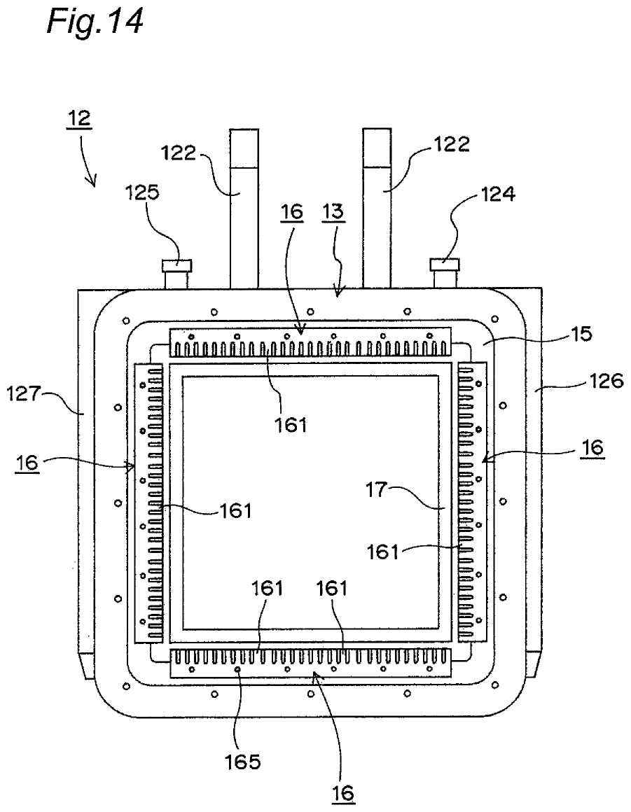

(3) As shown in FIG. 14, the comb-shaped contact member 16 is provided on each side of the main body 13, extending continuously over the entire length of each side. This makes it possible to simplify the assembly work of the frame body 12.

(4) The liquid inlet 124 is configured to allow a liquid to be injected and air to be purged. This eliminates the need for the air vent 125.

(5) The liquid inlet 124 and/or the air vent 125 are provided on the back panel 11.

(6) The workpiece holding jig is adapted to hold the workpiece 10 horizontally or obliquely, rather than vertically.

(7) The back panel 11 and the frame body 12 are fixed by a draw latch such as a toggle latch rather than the bolts 18.

(8) The plate-shaped workpiece 10 has a circular shape, a polygonal shape, or any other shape rather than a rectangular shape. Correspondingly, the back panel 11 and the frame body 12 also have a circular shape, a polygonal shape, or any other shape rather than a rectangular shape.

### INDUSTRIAL APPLICABILITY

Since the workpiece holding jig according to the present invention can prevent the workpiece or the contact member from being damaged when the workpiece that has been plated is removed from the workpiece holding jig, the workpiece holding jig has great industrial utility value.

### DESCRIPTION OF REFERENCE SIGNS

1A, 1B: Workpiece holding jig

10: Workpiece

101: Peripheral portion

11: Back panel

12: Frame body

126: Right guide bar

127: Left guide bar

128: Upper guide bar

129: Lower guide bar

13: Main body

15: Conductive member

16: Contact member

161: Contact terminal

17: Seal member

19: Wire

2A, 2B: Plating bath

231: Right guide rail

232: Left guide rail

251: Upper guide rail

252: Lower guide rail

3A, 3B: Transfer mechanism

31: Vertical transfer mechanism

32: First conveying mechanism

34: Horizontal transfer mechanism

35: Second conveying mechanism

20: Plating solution

4: Flux-reflux bath

5: Sealed space

9A, 9B: Electroplating apparatus

1. A workpiece holding jig for holding a workpiece having a plate shape, the workpiece being an object to be electroplated, the workpiece holding jig comprising:
a back panel; and
a frame body, wherein
the workpiece is held between the back panel and the frame body,
the frame body is configured to be attached to the back panel to hold a peripheral portion of the workpiece between the frame body and the back panel,
the frame body includes a main body having an annular shape, a conductive member provided all over the main body, a contact member provided along the conductive member, the contact member being electrically connected to the conductive member to come into electrical contact with the peripheral portion of the workpiece, and a seal member provided all over the main body and located on an inner side of the main body relative to the contact member,
the frame body is adapted to form a sealed space that accommodates the peripheral portion of the workpiece, the conductive member, and the contact member in a state where the seal member and the contact member are in contact with the peripheral portion of the workpiece, and
the conductive member has a wide and thick form to exhibit an approximately uniform resistance value at any point all over the conductive member.

2. The workpiece holding jig according to claim 1, wherein
the frame body or the back panel includes a liquid inlet through which a liquid is injected into the sealed space.

3. A workpiece holding jig for holding a workpiece having a plate shape, the workpiece being an object to be electroplated, the workpiece holding jig comprising:
a back panel; and
a frame body, wherein
the workpiece is held between the back panel and the frame body,
the frame body is configured to be attached to the back panel to hold a peripheral portion of the workpiece between the frame body and the back panel,
the frame body includes a main body having an annular shape, a wire provided all over the main body, a contact member provided along the wire, the contact member being electrically connected to the wire to come into electrical contact with the peripheral portion of the workpiece, and a seal member provided all over the main body and located on an inner side of the main body relative to the contact member,
the frame body is adapted to form a sealed space that accommodates the peripheral portion of the workpiece, the wire, and the contact member in a state where the seal member and the contact member are in contact with the peripheral portion of the workpiece, and
the frame body or the back panel includes a liquid inlet through which a liquid is injected into the sealed space.

4. The workpiece holding jig according to claim 1, wherein
the contact member is a comb-shaped contact member including a large number of contact terminals that have a leaf spring shape and are arranged side by side, the contact terminals being configured to come into electrical contact with the peripheral portion of the workpiece.

5. The workpiece holding jig according to claim 4, wherein
the main body of the frame body has a rectangular shape, and
the comb-shaped contact member is provided continuously or separately on each side of the main body.

6. An electroplating apparatus including the workpiece holding jig according to claim 1, the electroplating apparatus being configured to hold the workpiece with the workpiece holding jig and electroplate the workpiece thus held, the electroplating apparatus comprising:
a plating bath configured to hold a plating solution and electroplate the workpiece; and
a transfer mechanism configured to load and unload the workpiece holding jig holding the workpiece into and from the plating bath, wherein
the sealed space in the workpiece holding jig is filled with a liquid that contains no metal salt.

7. The electroplating apparatus according to claim 6, wherein
the liquid is tap water, natural water, or pure water, and
the pure water is deionized water, distilled water, purified water, or RO water.

8. The electroplating apparatus according to claim 6, wherein
the transfer mechanism includes a vertical transfer mechanism configured to load and unload the workpiece holding jig into and from the plating bath in a vertical direction.

9. The electroplating apparatus according to claim 8, wherein
a plurality of the plating baths are arranged side by side in a horizontal direction, and
the vertical transfer mechanism is connected to a first conveying mechanism configured to convey the workpiece holding jig to a loading and unloading position with respect to each of the plating baths.

10. The electroplating apparatus according to claim 8 or 9, wherein
the main body of the frame body has a rectangular shape,
the transfer mechanism is adapted to load and unload the workpiece holding jig holding the workpiece in an upright position into and from the plating bath,
the workpiece holding jig includes a right guide bar extending along a right side of the main body and a left guide bar extending along a left side of the main body, and
the plating bath includes a right guide rail configured to guide the right guide bar and a left guide rail configured to guide the left guide bar.

11. The electroplating apparatus according to claim 6, wherein
a flux-reflux bath is disposed in front of the plating bath,
the transfer mechanism includes a horizontal transfer mechanism configured to load and unload the workpiece holding jig into and from the plating bath and the flux-reflux bath in a horizontal direction.

12. The electroplating apparatus according to claim 11, wherein
a plurality of the plating baths and a plurality of the flux-reflux baths are arranged side by side in the horizontal direction, wherein
the horizontal transfer mechanism is connected to a second conveying mechanism configured to convey the workpiece holding jig to a loading and unloading position with respect to each of the plating baths.

13. The electroplating apparatus according to claim 11 or 12, wherein
the main body of the frame body has a rectangular shape,
the transfer mechanism is adapted to load and unload the workpiece holding jig holding the workpiece in an upright position into and from the plating bath,
the workpiece holding jig includes an upper guide bar extending along an upper side of the main body and a lower guide bar extending along a lower side of the main body, and
the plating bath and the flux-reflux bath each include an upper guide rail configured to guide the upper guide bar and a lower guide rail configured to guide the lower guide bar.

14. The workpiece holding jig according to claim 3, wherein
the contact member is a comb-shaped contact member including a large number of contact terminals that have a leaf spring shape and are arranged side by side, the contact terminals being configured to come into electrical contact with the peripheral portion of the workpiece.

15. The workpiece holding jig according to claim 14, wherein
the main body of the frame body has a rectangular shape, and
the comb-shaped contact member is provided continuously or separately on each side of the main body.

16. The electroplating apparatus according to claim 9, wherein
the main body of the frame body has a rectangular shape,
the transfer mechanism is adapted to load and unload the workpiece holding jig holding the workpiece in an upright position into and from the plating bath,
the workpiece holding jig includes a right guide bar extending along a right side of the main body and a left guide bar extending along a left side of the main body, and
the plating bath includes a right guide rail configured to guide the right guide bar and a left guide rail configured to guide the left guide bar.

17. The electroplating apparatus according to claim 12, wherein
the main body of the frame body has a rectangular shape,
the transfer mechanism is adapted to load and unload the workpiece holding jig holding the workpiece in an upright position into and from the plating bath,
the workpiece holding jig includes an upper guide bar extending along an upper side of the main body and a lower guide bar extending along a lower side of the main body, and
the plating bath and the flux-reflux bath each include an upper guide rail configured to guide the upper guide bar and a lower guide rail configured to guide the lower guide bar.

18. An electroplating apparatus including the workpiece holding jig according to claim 3, the electroplating apparatus being configured to hold the workpiece with the workpiece holding jig and electroplate the workpiece thus held, the electroplating apparatus comprising:
a plating bath configured to hold a plating solution and electroplate the workpiece; and
a transfer mechanism configured to load and unload the workpiece holding jig holding the workpiece into and from the plating bath, wherein
the sealed space in the workpiece holding jig is filled with a liquid that contains no metal salt.

19. The electroplating apparatus according to claim 18, wherein
the liquid is tap water, natural water, or pure water, and
the pure water is deionized water, distilled water, purified water, or RO water.
